(19) United States
(12) Patent Application Publication
(10) Pub. No.: US 2018/0181907 A1
(43) Pub. Date: Jun. 28, 2018

(54) MOBILE PLATFORM FOR INVENTORY AND DELIVERY SERVICE

(71) Applicant: Arash Esmailzadeh, Los Angeles, CA (US)

(72) Inventor: Arash Esmailzadeh, Los Angeles, CA (US)

(21) Appl. No.: 15/842,811

(22) Filed: Dec. 14, 2017

Related U.S. Application Data
(60) Provisional application No. 62/439,757, filed on Dec. 28, 2016.

(51) Int. Cl. G06Q 10/08; G06Q 20/40

(52) U.S. Cl. CPC G06Q 10/087; G06Q 10/083; G06Q 20/4014

(57) ABSTRACT

System and methods are disclosed for delivering an item in a mobile inventory to various users. The method includes: receiving mobile delivery device inventory data from a plurality of mobile delivery devices; updating an inventory database based on the mobile delivery device inventory data; receiving mobile delivery device GPS data from the plurality of mobile delivery devices; updating a location of each of the plurality of mobile delivery devices in a mobile delivery database based on the mobile delivery device GPS data; receiving first user GPS data from a first user device; identifying a subset of the plurality of mobile delivery devices that are located within a geographic region of the first user device based on the first user GPS data and the mobile delivery database; and retrieving a listing of available inventory items including a plurality of inventory items associated with the subset of plurality of mobile delivery devices.

### SUMMARY

Some embodiments include systems and methods for inventory and delivery services. In some embodiments, systems and methods may include: receiving, at a mobile delivery server, mobile delivery device inventory data from a plurality of mobile delivery devices; updating an inventory database based on the mobile delivery device inventory data; receiving, at the mobile delivery server, mobile delivery device GPS data from the plurality of mobile delivery devices; updating a location of each of the plurality of mobile delivery devices in a mobile delivery database based on the mobile delivery device GPS data; receiving at the mobile delivery server first user GPS data from a first user device; identifying a subset of the plurality of mobile delivery devices that are located within a geographic region of the first user device based on the first user GPS data and the mobile delivery database; retrieving a listing of available inventory items including a plurality of inventory items associated with the subset of plurality of mobile delivery devices; transmitting the listing of available inventory items to the first user; receiving a selection of inventory items from the first user that include one or more inventory items from the listing of available inventory items; and sending a delivery notification to one of the subset of plurality of mobile delivery devices, the delivery notification including instructions to deliver the selection of inventory items to the first user.

Some embodiments may include receiving payment information and/or authorization information from the first user.

In some embodiments, the geographic region may depend on a travel time between a mobile delivery device and the first user. In some embodiments, the geographic region may depend on a travel distance between a mobile delivery device and the first user. In some embodiments, the delivery notification may include GPS data of the first user.

Some embodiments may include decrementing the selection of inventory items from the listing of available inventory items.

Some embodiments may include sending a message to the first user indicating that the selection of inventory items is being delivered.

Some embodiments include systems and methods for inventory and delivery services. In some embodiments, systems and methods may include: receiving, at an app executing on a mobile device; information identifying an inventory item; updating, via the app executing on the mobile device, mobile delivery device inventory data with the information identifying an inventory item; transmitting at least the information identifying an inventory item to a mobile delivery server; collecting location data via the app executing on the mobile device; transmitting the location data to a mobile delivery server; and receiving, via the app executing on the mobile device, a request to deliver an inventory item listed in the mobile delivery device inventory data to a user, the request including location data of the user.

Some embodiments may include providing directions to the location of the user using the location data of the user. Some embodiments may include decrementing the inventory item from the inventory data.

In some embodiments, the request is initiated by a user mobile device indicating that the user of the user mobile device has selected the inventory to item for purchase and delivery.

In some embodiments the receiving, via the app executing on the mobile device, information identifying an inventory item further comprises capturing an image of a UPC code. In some embodiments the receiving, via the app executing on the mobile device, information identifying an inventory item further comprises capturing an image of the inventory item. In some embodiments the receiving, via the app executing on the mobile device, information identifying an inventory item further comprises receiving text via a user interface.

Some embodiments include systems and methods for inventory and delivery services. In some embodiments, a mobile delivery platform may include a plurality of mobile delivery devices, a mobile delivery server, and a plurality of user devices. In some embodiments, a plurality of mobile delivery devices may include a storage volume; and a mobile device having: a GPS unit; a wireless communication transceiver; and an inventory database comprising a listing of a plurality of products offered for sale and stored within the vehicle.

In some embodiments, the plurality of user devices may each include: a GPS unit; a wireless communication transceiver; a user interface; and a controller. In some embodiments, the controller may be configured to: communicate GPS data to a mobile delivery server via the wireless communication transceiver; receive location-specific inventory data from the mobile delivery server; present location-specific inventory data to a user via the user interface; receive a selection of inventory items from a user via the user interface; and communicate a selection of inventory items to the mobile delivery server.

In some embodiments, the mobile delivery server may include: a network interface configured to communicate with the wireless communication transceiver of the plurality of user devices and communicate with the wireless communication transceiver of the plurality of mobile delivery devices; a database, and a processor. The database may include: a listing of a plurality of products offered for sale and stored within each of the plurality of vehicles of the plurality of mobile delivery devices; and a listing of the locations of the plurality of mobile delivery devices. The processor may be configured to: receive user GPS data from a first user device of the plurality of user devices; receive mobile delivery device GPS data from one or more mobile delivery devices of the plurality of mobile delivery devices; determine the location of one or more mobile delivery devices of the plurality of mobile delivery devices within a geographic region of the first user device based on the user GPS data and the mobile delivery device GPS data; send inventory data associated with the one or more mobile delivery devices of the plurality of mobile delivery devices within the geographic region to the first user device via the network interface; receive a selection of one or more inventory items from the first user device via the network interface; and send a message to a mobile delivery device of the plurality of mobile delivery devices that includes the selection of one or more inventory items, the message including a location related to the user GPS data and the selection of one or more inventory items.

In some embodiments, the processor may be configured to decrement the inventory item from the database. In some embodiments, the processor may be configured to send a message to the first user device via the network interface indicating that a mobile delivery device will deliver the selection of one or more inventory items.

### BRIEF DESCRIPTION OF THE DRAWINGS

A description of some embodiments of the invention will be rendered by reference to specific embodiments thereof which are illustrated in the appended drawings. It is appreciated that these drawings depict only typical embodiments of the invention and are not to be considered limiting of its scope. Some embodiments and examples of the invention will be described and explained with additional specificity and detail through the use of the accompanying drawings in which:

FIG. 1 illustrates a block diagram of a network that can be used to facilitate mobile inventory and delivery services according to some embodiments.

FIG. 2 illustrates a block diagram of a database used in the computer network that can be used to facilitate mobile inventory and delivery services according to some embodiments.

FIG. 3 is a flow diagram of an example inventory management procedure performed by a server in the computer network that facilitates mobile inventory and delivery services according to some embodiments.

FIG. 4 is a flow diagram of an example transaction procedure performed by a server in the computer network that facilitates mobile inventory and delivery services according to some embodiments.

FIG. 5 is a block diagram of an example computational system according to some embodiments.

### DISCLOSURE

Advances in many technology areas have produced a more internet centric populace. Because of this, many technological problems related to the internet and computer technology have arisen. In recent years, many of these technological problems have been related to making activities in the day to day lives of users more convenient, secure, and efficient. As illustrated in this discussion below, improved internet and computer technology can solve these internet and computer related problems, and improve the quality of life for the users of such technology.

Some embodiments include a system that allows remote users to order goods from any number of mobile delivery vehicles. For example, a user may be interested in purchasing a bag of chips and a soda and would prefer to not travel to do so. A plurality of drivers may maintain an inventory of goods within the driver's vehicle. Some embodiments may include a system that coordinates the requests of users for specific goods with the inventory of goods within one or more vehicles close to the user's location. In some embodiments, the system may include a server that maintains an inventory of goods within a plurality of vehicles as well as includes information about the location of the plurality of vehicles.

For example, a user may open an application executing on a mobile device to request delivery of a good. The application may send location information to the server. Based on the user's location information, the server may provide a listing of goods to the user that are available within one or more mobile vehicles that are currently located within a given radius or geographic location relative to the user's location. The user may then select a specific good from the listing of goods. The driver of the vehicle with the selected good will be notified and directed to the user's location. When the vehicle is at the user's location or near the user's location, the server may alert the user (e.g., via a text message or an app notification) that the driver with the selected good has arrived. The user and the driver may then consummate a transaction for the selected good. The transaction, for example, may be consummated using credit care information stored within the server.

As another example, a driver may have a plurality of different types of goods for sale that are kept within his vehicle. The driver may inventory the plurality of goods using an application executing on a mobile device. For example, the driver may take pictures of the goods and/or the UPC code on the goods. The driver may also provide a quantity, size, quality, price, title, description, and/or explanation for each item. The application may send the inventory of goods to a central server along with the location of the driver. The location of the driver, for example, may change over time as the driver travels over time. The server may store the inventory of goods at a storage location associated with the server (e.g., a remote, network storage location). The location of the driver may be sent to the server from time to time and/or saved within a file at the server to identify the location of the driver. In this way, for example, the server may maintain an inventory of goods available within a plurality of vehicles at a plurality of different locations. In response to a request for goods, the server may provide a listing of inventory items located within a geographic location.

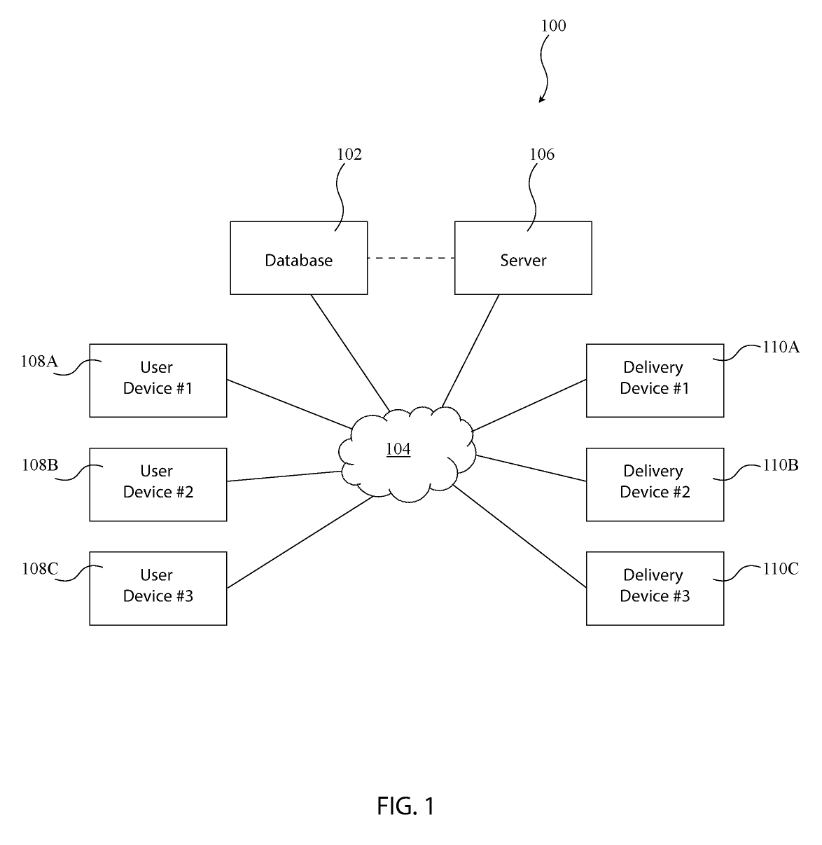

FIG. 1 is a block diagram of a computer network 100 that can facilitate mobile inventory and delivery services according to some embodiments. The computer network 100, for example, may include a database 102 connected to a network 104. A server 106 may also be connected to the network 104. The server 106 may also be connected to the database 102 independently of the network 104, or simultaneously through both an independent connection to the database 102 and through a connection to the network 104, or solely through the network 104. The server 106 may include one or more servers distributed in geographically remote locations or in a central location.

The network 104, for example, may include the Internet, a mobile network, a wireless network, or any combination thereof.

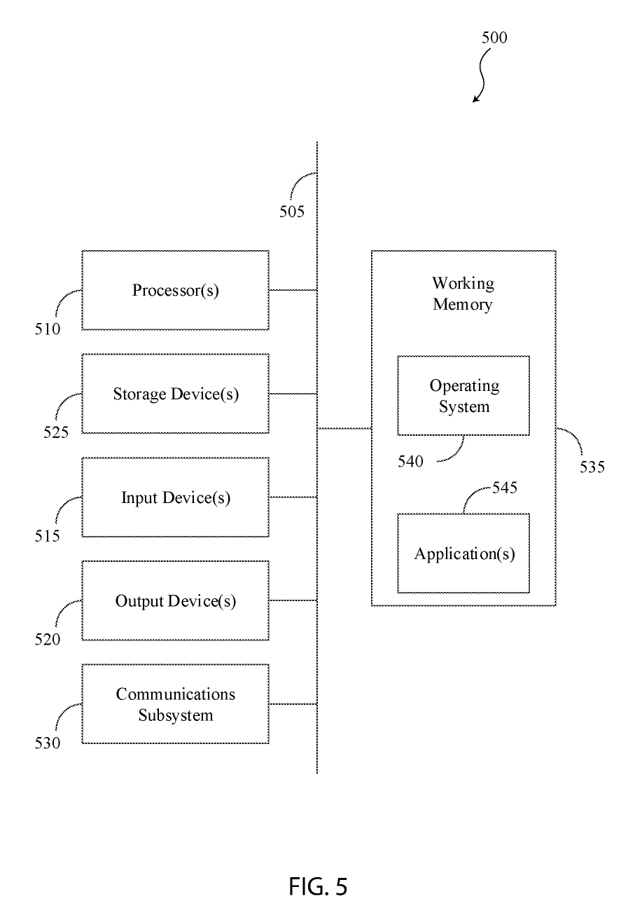

One or more user devices 108 (e.g., 108A, 108B, 108C, etc.) may also be connected to the network 104. A user device 108, for example, may include one or more components of computational device 500 shown in FIG. 5. A user device 108 may include any type of computing device such as, for example, a user device cellular device, a portable computer, a television, a mobile device, a tablet, a wearable device, a smartphone, etc. Each user device 108 may access the network 104 via an application installed on the user device 108. In some embodiments, the application may be an app executing on the user device 108 and/or a web browser.

One or more mobile delivery devices 110 (e.g., 110A, 110B, 110C, etc.) may also be connected to the network 104. A mobile delivery device 110, for example, may include one or more components of computational device 500 shown in FIG. 5. A mobile delivery device 110 may include any type of computing device such as, for example, a user device, cellular device, a portable computer, a television, a mobile device, a tablet, a wearable device, a smartphone, etc. In some embodiments, a mobile delivery device 110 may include a computing device contained within a smart phone or mobile device of a user operating a vehicle, a vehicle computer, an autonomous computing device, a drone, a computing device coupled with a bicycle, etc. Each mobile delivery device 110 may access the network 104 via an application installed on the mobile delivery device 110. In some embodiments, the application may be an app executing on the user device 108 and/or a web browser.

In some embodiments, the server 106 may perform any of a variety of operations. For example, the server 106 may facilitate an electronic connection between a user device(s) 108 and/or a delivery device(s) 110. In another example, the server 106 may perform inventory management procedures. The server 106 may also manage and/or coordinate the communications between the user device(s) 108, delivery device(s) 110 and database server 102. As another example, the server 106 may authenticate login credentials of user device(s) 108 and/or delivery device(s) 110. As another example, the server 106 may authenticate transactions between user device(s) 108 and delivery device(s) 110. As another example, the server 106 may process user device(s) 108 payments, and/or may validate mobile delivery device 110 bank accounts. As another example, the server 106 may perform a variety of other analytical functions. The server 106 may also manage which user device(s) 108 and delivery device(s) 110 may access the network 104.

In some embodiments, the server 106 may execute all or portions of process 300 and/or all or portions of process 400.

In some embodiments, delivery device(s) 110 may be restricted based on their characteristics, such as their personal resume, photos or videos of their delivery vehicle or apparatus, the delivery user's resume or other personal information, etc.

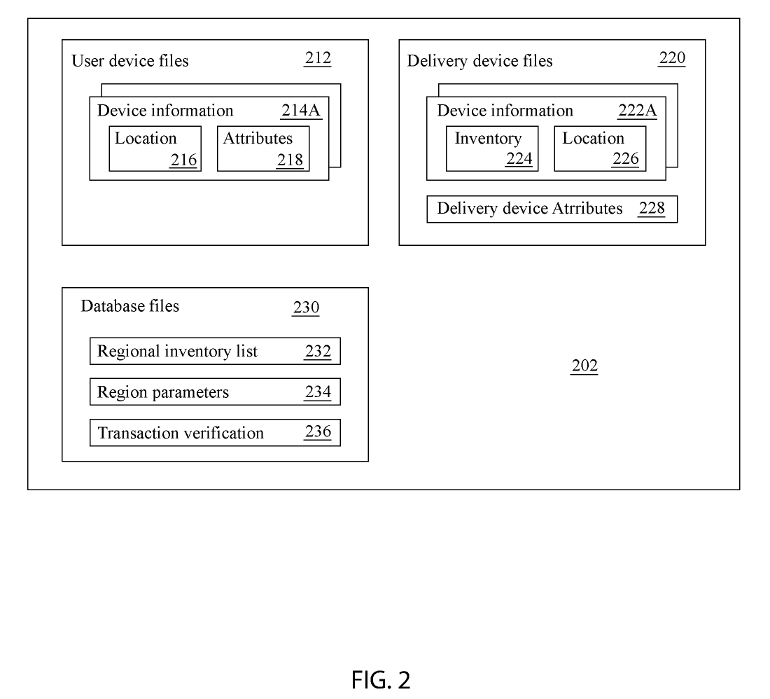

FIG. 2 illustrates a block diagram of a database structure 202 for data stored in database 102 that may be used by the server 106. For example, the database structure 202 may be used by the server 106 in the computer network 100 to store electronic information obtained and or generated by the server 106. For example, the database structure 202 may include user device files 212. User device files 212 may include a number of files from one of the one or more user devices 108 connected to the computer network 100. User device files 212 may exist for each user, and user device 108 of the one or more user devices 108. User device files 212 may include files related to a particular user regardless of what user device 108 the user uses to access the computer network 100. User device files 212 may also include files related to a particular user device 108. For example, user device files 212 could include files related to a particular user device 108 in user device information 214. Further, user device files 212 could include files related to particular user in user attributes 218.

This user device information 214 could include a variety of information about each user device 108 of the one or more user devices 108. This information may include the user device location 216 of one user device 108 for each of the one or more user devices 108. The user device location 216 of a user device 108 may be determined a number of different ways. For instance, a user device 108 may include a global positioning system (GPS) that monitors the geolocation of the user device 108. This GPS system may be operating on the user device 108, and the user device 108 may send the geolocation of the user device 108 to the database 106. This GPS system may also be operating on an application downloaded to the user device 108, and the application may send the geolocation of the user device 108 to the database 106. The geolocation of the user device 108 may be periodically sent to the database structure 202. The geolocation of each of the one or more user devices 108 may be stored in an application operating on the user device 108. The application may send the stored geolocation to the database structure 202 for storage in the user device location 216 file.

For example, after the application on a user device 108 periodically stores GPS data about that user device 108, the application may periodically send the GPS coordinates of the user device 108 to the database structure 202. In another example, the application on a user device 108 could store GPS data about that user device 108 and send the GPS coordinates of the user device 108 to the database structure 202, after a user initiates a request to purchase a good. These GPS coordinates may indicate that the user device 108, for example, is traveling at specific various points in Salt Lake City.

As another example of how the user device location 208 of the one or more user devices 108 may be determined, the application operating on the user device 108 may use a triangulation method. The application operating on the user device 108 may use cellular triangulation or data connection triangulation, a method which uses the data connection provided by either cellular towers or the method for which the computing device is receiving and sending data, to determine the one or more user devices 108 geolocation. For instance, the cellular connection of the one or more user devices 108 may be used by the database structure 202 to triangulate the geolocation of any particular user device 108. Geolocation information could be stored in the user device location 208 file of that user device's 109 user device information 214 file in the user device files 212 on the database structure 202.

Other methods of determining user device location 216 may also be used, such as, for example, using the user devices' internet protocol address, manual input of an address into one of the one or more user devices 108, etc. User device location 216 may be used to exclude certain user devices 108 from accessing the network 104. For example, it may be desirable to limit the operation of the network in a particular area for reasons like high rates of crime, limited parking, limited drop off availability, proven unworkability, time restrictions, or other reasons. A user device location 216 that is within that restricted geographic area may then limit the user device's 108 access to the network 104.

There may be a user attribute 218 file in each user device information 214 file in the user device files 212 on the database structure 202. Each user attributes 218 file may correspond to the particular attributes of one particular user device 108 of the one or more user devices 108. For example, the user attributes 218 of one particular user device 108 of the one or more user devices 108s could include that particular user device's 108 transaction history, email address, cell phone number, name, other contact information, payment information, review history, payment history, set acceptable wait times, set acceptable wait times with respect to inventory price, type of computing device, and or other attributes. User attributes 218 may also include nutritional preferences such as desired caloric content of inventories.

The user attributes 212 may be used to perform certain administrative functions. For example, user attributes 212 may be used to compute whether a particular user device 108 of the one or more user devices 108 has a history of submitting poor or inappropriate reviews. Additionally, user attributes 212 may be used to compute customer product preference based on a user device's 108 transaction history.

The database structure 202 may also contain delivery device files 220. Delivery device files 220 may be a number of files from the one or more delivery devices 108 connected to the computer network 100. There may be delivery device information 222 for each mobile delivery device 110 of the one or more mobile delivery devices 110. Delivery device files 220 could include specific files for each particular mobile delivery device 110 of the one or more mobile delivery devices 110. Delivery device files 220 could include delivery device information 222.

Each of the delivery device information 222 could include a variety of information about one particular mobile delivery device 110 of the one or more mobile delivery devices 110. The delivery device information 222 for one particular mobile delivery device 110 of the one or more mobile delivery devices 110 may include inventory verifications 224 for that particular mobile delivery device 110. Inventory verifications 224 may be confirmations of what particular inventory item is possessed by a particular mobile delivery vehicle that corresponds to a particular mobile delivery device 110 of the one or more mobile delivery devices 110. For example, inventory verifications 224 may be a barcode scan of a particular inventory item, a picture of a particular inventory item, a manual entry on the mobile delivery device 110 indicating a particular inventory item is possessed by a particular mobile delivery vehicle, or other confirmation that an inventory is possessed.

For example, one mobile delivery device 110 of the one or more mobile delivery devices 110 may indicate that the delivery device's 110 corresponding mobile delivery vehicle possesses a particular type of candy. The mobile delivery device 110 of the one or more mobile delivery devices 110 may create an inventory verification 224 of that candy by scanning the candy's barcode. The barcode information could then be used to determine the type of inventory, to determine what a correct image of the inventory is, etc. In another example, one mobile delivery device 110 of the one or more mobile delivery devices 110 may indicate that the delivery device's 110 corresponding mobile delivery vehicle possesses a certain beverage. The one mobile delivery device 110 of the one or more mobile delivery devices 110 may create an inventory verification 224 by taking a picture of the beverage.

Delivery device information 222 for one particular mobile delivery device 110 of the one or more mobile delivery devices 110 may also include delivery device location 226. The application operating on the delivery device(s) 110 may periodically obtain the geolocation of one particular mobile delivery device 110 of the one or more mobile delivery devices 110. The application may then send the geolocation of the mobile delivery device 110 to the delivery device location 226 file. The delivery device location 226 file may function in the same manner as the user device location 216 file described above.

The delivery device location 226 of one particular delivery device 108 of the one or more delivery devices 108 may be determined a number of different ways. For instance, each mobile delivery device 110 of the one or more mobile delivery devices 110 may include a global positioning system (GPS) that monitors the geolocation of each mobile delivery device 110. An application operating on the one or more mobile delivery devices 110 may periodically obtain the geolocation from the delivery device(s) 110 GPS. This application may periodically send the geolocation of one particular mobile delivery device 110 of the one or more mobile delivery devices 110 to the database structure 202. Specifically, the application may send the geolocation to the delivery device location 226 file on the delivery device information 222 file that corresponds to that particular mobile delivery device 110 of the one or more mobile delivery devices 110.

As another example of how the location of one or more mobile delivery devices 110 may be determined, the application operating on the delivery device(s) 110 may use a triangulation method. The application operating on the delivery device(s) 110 may use cellular triangulation or data connection triangulation, a method which uses the data connection provided by either cellular towers or the method for which the computing device is receiving and sending data, to determine the computing device's geolocation.

For instance, the cellular connection of one particular mobile delivery device 110 of the one or more mobile delivery devices 110 may be used by an application operating on the delivery device(s) 110 to triangulate the geolocation of that particular mobile delivery device 110 of the one or more mobile delivery devices 110. Other methods of geolocation may also be used. The geolocation information for a particular mobile delivery device 110 of the one or more mobile delivery devices 110 may be stored in the delivery device location 226 file of the delivery device information 222 file that corresponds to that particular mobile delivery device 110 of the one or more mobile delivery devices 110. Other methods of determining delivery device location 226 may also be used, such as using the computing devices internet protocol address, and the manual input of address into one of the one or more mobile delivery devices 110, etc.

There may be a delivery device attributes 228 file in each delivery device information 222 file in the delivery device files 220 on the database structure 202. Delivery device attributes 228 may correspond to the particular attributes of one particular mobile delivery device 110 of the one or more mobile delivery devices 110. Delivery device attributes 228 of a particular mobile delivery device 110 of the one or more mobile delivery devices 110 may include that particular delivery device's 110 owner's transaction history, user contact information, methods of payment accepted, sales performance, performance reviews, customer reviews, type of computing device, location history, and or other attributes.

The database structure 202 may also include database files 230. Database files 230 may include regional inventory lists 232. The regional inventory lists 232 may include all the inventory verifications 224 from all the one or more mobile delivery devices 110, sorted into one or more lists determined by region parameters 234. For example, inventory verifications 224 from mobile delivery devices 110 in a particular fifty-mile radius may be grouped into one particular regional inventory list 232 corresponding to that 50 mile radius. As another example, all inventory verifications 224 from mobile delivery devices 110 in a given area such as, for example, the Los Angeles area, will be grouped into the regional inventory list 232 corresponding to the given area such as, for example, Los Angeles.

The server 106 may determine how to group inventory verifications 224 from the one or more mobile delivery devices 110 according to set region parameters 234 and store the grouped inventory verifications 224 in regional inventory lists 232. Region parameters 234 may be set by the server 106 and may include settings for how the server 106 determines which inventory verifications 224 to add to which regional inventory list 232. Region parameters 234 may include rules to determine how large a region is, rules that determine regions based on serviceable population, rules that determine regions based on geographic radius from a particular geographic point, rules that determine regions based on topographic boundaries, and or by other logical delineators.

The database files 230 may also include transaction verification files 236. Transaction verification files 236 may correspond to files that evidence a completed sale and delivery of an item in inventory. Transaction verification files 236 may include credit card payment verification, barcode out scanning of the item of inventory, confirmation from the user device 108, confirmation from a mobile delivery device 110, audio recordings of the transaction, video or photographic recordings of a transaction, fingerprint confirmation of a transaction, eye recognition confirmation of a transaction, and other methods.

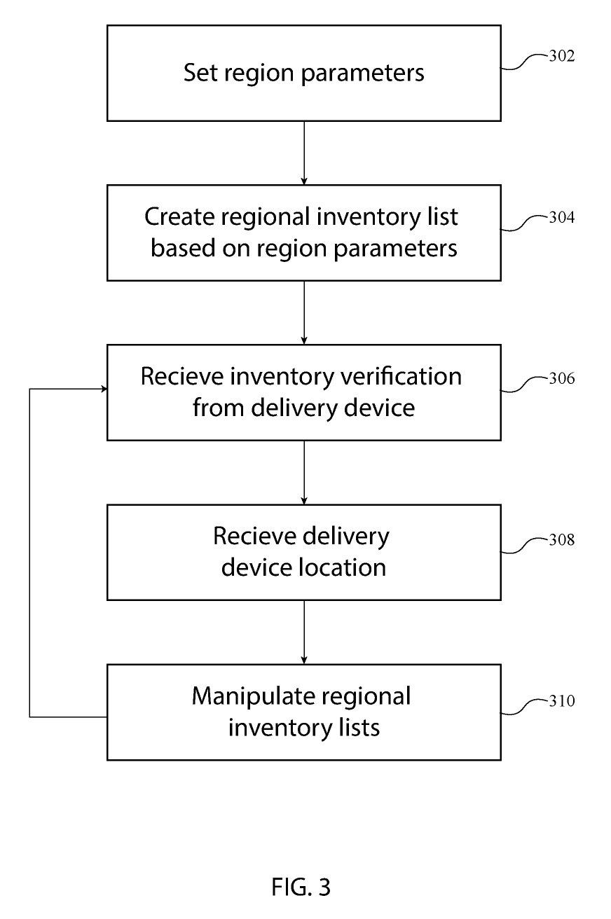

FIG. 3 is a flow diagram of an exemplary inventory management procedure 300 performed by the server 106 in the computer network 100 that facilitates mobile inventory and delivery services.

To manage inventory that can be used in remote sales and delivery, the server 106 may set at block 302 region parameters 234.

Then the server 106 may create, at block 304, regional inventory lists 232 based on region parameters 234.

The server 106 may then receive at block 306 inventory verifications 222 of the one or more mobile delivery devices 110.

At block 308, the server 106 may also receive delivery device locations 226.

The server may then manipulate at block 310 the regional inventory lists 232.

For example, the server 106 may set at block 302 region parameters 234 that correspond to all major metro area city boundaries. The server 106 may then create, at block 304, regional inventory lists 232 based on those region parameters 234. In this particular example, regional inventory lists 232 would be created for each major metro area city boundary. The server 106 may then receive at block 306 inventory verifications 224 and receive at block 308 delivery device locations 226 for the one or more mobile delivery devices 110. The server 106 would then at block 310 manipulate the regional inventory lists 232 to reflect the mobile delivery device 110 inventory verifications 224 and locations 226. This manipulation may be accomplished by either adding, subtracting, altering, sorting, erasing, and or editing information or through a number of other operations. In this example, the server 106 would manipulate at block 310 the regional inventory lists 232 by sorting the inventory verifications 224 by their respective delivery device locations 226 to determine which regional metro area city boundary they corresponded to, and then manipulate at block 310 the corresponding regional inventory lists 232 to reflect the inventory verifications 224 from that regional metro area city boundary. As one specific example, the server 106 may sort the inventory verifications 224 into groups of inventory verifications 224 sent from mobile delivery devices 110 with locations in Los Angeles, and inventory verifications 224 sent from mobile delivery devices 110 with locations in San Diego. The server would then manipulate the Los Angeles regional inventory list 232 and the San Diego regional inventory list 232 to reflect the inventory verifications 224 from those respective regions.

After manipulating the regional inventory lists 232, the server 106 may return to block 306 and perform the process again. By repeatedly performing this process, the server 106 may manage the regional inventory lists 232 to reflect the most recent inventory verifications 224 and delivery device locations 226.

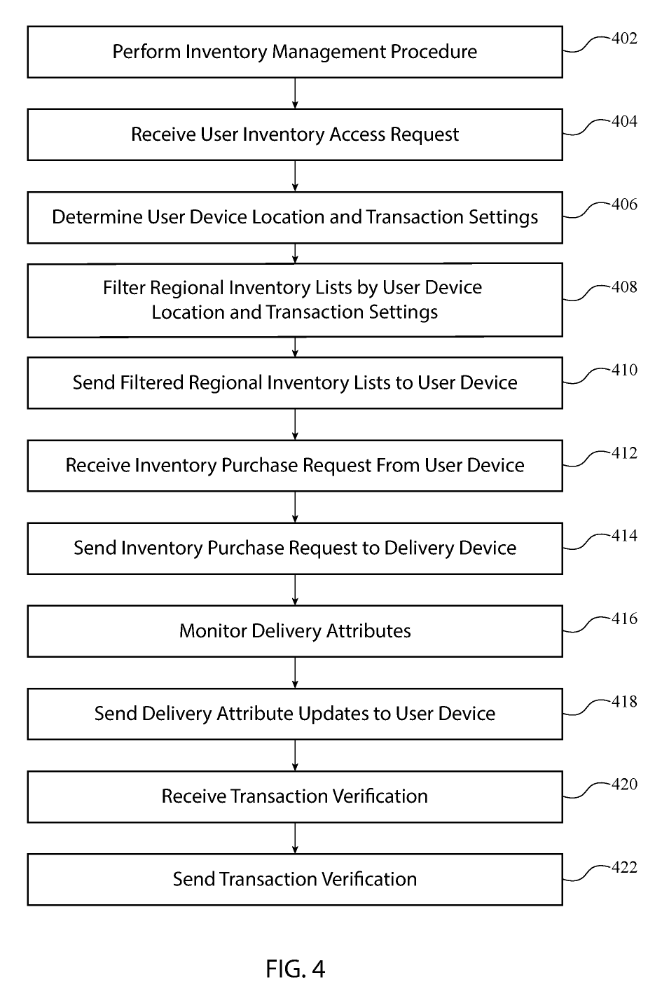

FIG. 4 illustrates a flow diagram of an example transaction procedure performed by the server 106 in the computer network 100 that facilitates mobile inventory and delivery services.

The server 106 may perform at block 402 the inventory management procedure 300 discussed in relation to FIG. 3.

Then, the server 106 may receive at block 404 a user inventory access request from one of the one or more user devices 108. A user inventory access request may be a request for the server 106 to send regional inventory lists 232 to the user device 108.

To determine which regional inventory lists 232 to send to the user device 108 in response to the user inventory access request, the server 106 may determine at block 406 the user device location 216 and user attributes 218.

The server 106 may filter at block 408 the regional inventory lists 232 by the user device location 216 and user attributes 210. Filtering at block 408 the regional inventory lists 232 by user device location 216 and user attributes 218 may include selecting the regional inventory list 232 that corresponds to the user device location 216 and removing inventory verifications 224 from that selected regional inventory list 232 that do not correspond to the user attributes 218. Thus, filtering at block 408 the regional inventory lists 232 provides the regional inventory lists 232 that contains items within the user devices region, and with items that meet the user attributes 218.

For example, the server 106 may receive at block 404 a user inventory access request from one user device 108 of the one or more user devices 108. The user device 108 sending the user inventory access request may have a user device location 216 at a particular address in Seattle, and may have user attributes 218 that indicate the user only wishes to wait 5 minutes and does not wish to pay more than 10 dollars for a particular inventory. The server 106 may filter at block 408 the regional inventory lists 232 to only those that correspond to the Seattle area. Once the regional inventory lists 232 are filtered at block 408 to reflect only Seattle based regional inventory lists 232, the Seattle regional inventory lists 232 may be filtered at block 408 to remove inventory verifications 224 from those Seattle regional inventory lists 232 that price the user device's 108 desired inventory at more than 10 dollars. The Seattle regional inventory lists 232 may then be filtered at block 408 to remove inventory verifications 224 that indicate a delivery device location 226 that is further than 5 minutes away from the user device location 216.

As an additional example, the regional inventory lists 232 may be filtered at block 408 by the type of inventory as determined by user attributes 218. For example, the regional inventory lists 232 may be filtered at block 408 to remove any inventory listing that is not responsive to the type of product determined by the user attributes 218. For instance, the user attributes 218 may indicate that the user device 108 desires a regional inventory lists 232 that is populated by inventory of a particular category (i.e. chocolate candies, soft drinks, sandwiches, cigarettes, hot drinks, snacks, etc.). The regional inventory lists 232 may also be filtered at block 408 by what particular inventory a mobile delivery device 110 possess. This would then result in displaying a regional inventory list that indicated which mobile delivery devices 110 possess all the inventory for which the user device 108 is interested in. This method could be used to incentivize a user device 108 to purchase inventories owned by a single mobile delivery device 110.

The server 106 may then send at block 410 the filtered regional inventory lists 232 to the user device 108.

The server 106 may then receive at block 412 an inventory purchase request from the user device 108. The inventory purchase request may reflect one or more of the items of inventory listed on the filtered regional inventory lists 232 that were sent at block 410 to the user device 108. The inventory purchase request may indicate that the user device 108 would like to purchase a particular inventory.

The server 106 may then send at block 414 the inventory purchase request to the mobile delivery device 110 that possesses the item of inventory wanted by the user device 108 for purchase and delivery. The inventory purchase request will indicate to the mobile delivery device 110 that the user device 108 making the inventory purchase request would like to engage in a purchase and delivery transaction with the mobile delivery device 110. The mobile delivery device 110 would then take action to facilitate the delivery and sale of the item of inventory. Such action could include driving the item of inventory to the user device location 216. Such action could include driving an item to another mobile delivery device 110 which would deliver the inventory. The server 106 may be capable of coordinating between many mobile delivery devices 110 so as to coordinate multiple mobile delivery device 110 exchanges to that results in one overall delivery to a user device 108. Such action could include using an unmanned or manned delivery apparatus to move the item to the user device location 216 or some other location. Other methods of delivery are possible.

The server 106 may monitor at block 416 the delivery attributes of the transaction between the user device 108 and mobile delivery device 110. Delivery attributes may include the relative distance between the user device location 216 and the delivery device location 226, the estimated time for when the mobile delivery device 110 will reach the user device 108, the delivery device location 226 and the user device location 216 displayed graphically on a map, and other potential attributes.

The server 106 may send at block 418 delivery attribute updates to the user device 108 or mobile delivery device 110 if either one is not near the delivery location. The server 106 may send at block 418 updates of the delivery attributes to the user device 108.

The server may then receive at block 420 transaction verification files 236 from the mobile delivery device 110 and or user device 108. Transaction verification files 236 are discussed above in relation to FIG. 2.

The server 106 may then return and perform at block 402 the inventory management procedure described in connection with FIG. 3. The server 106 may also then send at block 422 the transaction verification files 236 to the database server 102.

The computational system 500, shown in FIG. 5 can be used to perform any of the embodiments of the invention. For example, computational system 500 can be used to execute methods 400 or any other process or method described in this disclosure. As another example, computational system 500 can be used perform any calculation, identification and/or determination described here. Computational system 500 includes hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computational system 500 may further include (and/or be in communication with) one or more storage devices 525, which can include, without limitation, local and/or network accessible storage and/or can include, without limitation, a disk drive, a drive array, an optical storage device, a solid-state storage device, such as a random-access memory (“RAM”) and/or a read-only memory (“ROM”), which can be programmable, flash-updateable and/or the like. The computational system 500 might also include a communications subsystem 530, which can include without limitation a modem, a network card (wireless or wired), an infrared communication device, a wireless communication device and/or chipset (such as a Bluetooth device, an 802.6 device, a Wi-Fi device, a WiMAX device, cellular communication facilities, etc.), and/or the like. The communications subsystem 530 may permit data to be exchanged with a network (such as the network described below, to name one example), and/or any other devices described herein. In many embodiments, the computational system 500 will further include a working memory 535, which can include a RAM or ROM device, as described above.

The computational system 500 also can include software elements, shown as being currently located within the working memory 535, including an operating system 540 and/or other code, such as one or more application programs 545, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 525 described above.

In some cases, the storage medium might be incorporated within the computational system 500 or in communication with the computational system 500. In other embodiments, the storage medium might be separate from a computational system 500 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.) then takes the form of executable code.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, at a mobile delivery server, mobile delivery device inventory data from a plurality of mobile delivery devices;
updating an inventory database based on the mobile delivery device inventory data;
receiving, at the mobile delivery server, mobile delivery device GPS data from the plurality of mobile delivery devices;
updating a location of each of the plurality of mobile delivery devices in a mobile delivery database based on the mobile delivery device GPS data;
receiving at the mobile delivery server first user GPS data from a first user device;
identifying a subset of the plurality of mobile delivery devices that are located within a geographic region of the first user device based on the first user GPS data and the mobile delivery database;
retrieving a listing of available inventory items including a plurality of inventory items associated with the subset of plurality of mobile delivery devices;
transmitting the listing of available inventory items to the first user;
receiving a selection of inventory items from the first user that include one or more inventory items from the listing of available inventory items; and
sending a delivery notification to one of the subset of plurality of mobile delivery devices, the delivery notification including instructions to deliver the selection of inventory items to the first user.

2. The method according to claim 1, further comprising receiving payment information and/or authorization information from the first user.

3. The method according to claim 1, wherein the geographic region depends on a travel time between a mobile delivery device and the first user.

4. The method according to claim 1, wherein the geographic region depends on a travel distance between a mobile delivery device and the first user.

5. The method according to claim 1, wherein the delivery notification comprises GPS data of the first user.

6. The method according to claim 1, further comprising decrementing the selection of inventory items from the listing of available inventory items.

7. The method according to claim 1, further comprising sending a message to the first user indicating that the selection of inventory items is being delivered.

8. The method according to claim 1, wherein transmitting the listing of available inventory items to the first user includes transmitting an image of available inventory items.

9. A method comprising:
receiving, at an app executing on a mobile device, information identifying an inventory item;
updating, via the app executing on the mobile device, mobile delivery device inventory data with the information identifying an inventory item;
transmitting at least the information identifying an inventory item to a mobile delivery server;
collecting location data via the app executing on the mobile device;
transmitting the location data to a mobile delivery server; and
receiving, via the app executing on the mobile device, a request to deliver an inventory item listed in the mobile delivery device inventory data to a user, the request including location data of the user.

10. The method according to claim 9, further comprising providing directions to the location of the user using the location data of the user.

11. The method according to claim 9, wherein the request is initiated by a user mobile device indicating that the user of the user mobile device has selected the inventory to item for purchase and delivery.

12. The method according to claim 9, further comprising decrementing the inventory item from the inventory data.

13. The method according to claim 9, wherein receiving, via the app executing on the mobile device, information identifying an inventory item further comprises capturing an image of a UPC code.

14. The method according to claim 9, wherein receiving, via the app executing on the mobile device, information identifying an inventory item further comprises capturing an image of the inventory item.

15. The method according to claim 9, wherein receiving, via the app executing on the mobile device, information identifying an inventory item further comprises receiving text via a user interface.

16. The method according to claim 9, wherein information identifying an inventory item includes an image of the inventory item.

17. A mobile delivery platform comprising:
a plurality of mobile delivery devices including:
a storage volume; and
a mobile device having:
a GPS unit;
a wireless communication transceiver; and
an inventory database comprising a listing of a plurality of products offered for sale and stored within the vehicle;
a plurality of user devices, each user device of the plurality of user devices comprising:
a GPS unit;
a wireless communication transceiver;
a user interface; and
a controller configured to:
communicate GPS data to a mobile delivery server via the wireless communication transceiver;
receive location-specific inventory data from the mobile delivery server;
present location-specific inventory data to a user via the user interface;
receive a selection of inventory items from a user via the user interface; and
communicate a selection of inventory items to the mobile delivery server;
the mobile delivery server comprising:
a network interface configured to communicate with the wireless communication transceiver of the plurality of user devices and communicate with the wireless communication transceiver of the plurality of mobile delivery devices;
a database comprising:
a listing of a plurality of products offered for sale and stored within each of the plurality of vehicles of the plurality of mobile delivery devices; and
a listing of the locations of the plurality of mobile delivery devices; and
a processor configured to:
receive user GPS data from a first user device of the plurality of user devices;
receive mobile delivery device GPS data from one or more mobile delivery devices of the plurality of mobile delivery devices;
determine the location of one or more mobile delivery devices of the plurality of mobile delivery devices within a geographic region of the first user device based on the user GPS data and the mobile delivery device GPS data;
send inventory data associated with the one or more mobile delivery devices of the plurality of mobile delivery devices within the geographic region to the first user device via the network interface;
receive a selection of one or more inventory items from the first user device via the network interface; and
send a message to a mobile delivery device of the plurality of mobile delivery devices that includes the selection of one or more inventory items, the message including a location related to the user GPS data and the selection of one or more inventory items.

18. The mobile delivery platform according to claim 17, further comprising decrementing the inventory item from the database.

19. The mobile delivery platform according to claim 17, further comprising send a message to the first user device via the network interface indicating that a mobile delivery device will deliver the selection of one or more inventory items.

20. The mobile delivery platform according to claim 17, wherein information identifying an inventory item includes an image of the inventory item.
